(19) United States
(12) Patent Application Publication
(10) Pub. No.: US 2026/0307050 A1
(43) Pub. Date: Oct. 8, 2026

(54) THE METHOD OF OBTAINING POLYACRYLAMIDE HYDROGELS THROUGH CONTINUOUS FRONTAL POLYMERIZATION

(71) Applicant: DAVID SEVANOVICH DAVTYAN, Moscow (RU)

(72) Inventors: DAVID SEVANOVICH DAVTYAN, Moscow (RU); SEVAN PARUYROVICH DAVTYAN, Moscow (RU); ANAIT OGANESOVNA TONOYAN, Moscow (RU)

(73) Assignee: GREEN EVOLUTION TECHNOLOGIES, INC., Estherville, IA (US)

(21) Appl. No.: 18/998,470

(22) PCT Filed: Nov. 3, 2023
(86) PCT No.: PCT/RU2023/050255

§ 371 Date: Jan. 25, 2025

(30) Foreign Application Priority Data
Sep. 13, 2022 (RU) 2022124187

(51) Int. Cl. B01J 20/26; B01J 13/00; B01J 19/02; B01J 19/24; B01J 20/28; B01J 20/30; C08F 220/56

(52) U.S. Cl. CPC B01J 20/261; B01J 13/0052; B01J 19/02; B01J 19/24; B01J 20/28047; B01J 20/3085; C08F 220/56; B01J 2219/00033; B01J 2219/0245; C08F 2810/20; C08F 2810/50

(57) ABSTRACT

The invention relates to the field of polymer chemistry and concerns the industrial technology of obtaining superabsorbents, in particular polyacrylamide hydrogel (PAH), which can be used in agriculture, medicine, cosmetology, for cleaning oil pipelines and for creating hygiene items. The technical result achieved in the implementation of the claimed invention consists in reducing the labor intensity in the implementation of the technology of obtaining polyacrylamide hydrogel, in increasing the reliability of the hydrogel production process by achieving stability of the polymerization process, as well as in improving the quality of the resulting polyacrylamide hydrogel by significantly improving the homogeneity of the hydrogel, in the possibility of stable and accurate production of pores of the specified size and density, as well as the elimination of toxicity of the finished product. The method of producing polyacrylamide hydrogels by continuous frontal polymerization, including feeding acrylamide or its derivatives into a vertical continuous reactor from bottom to top and polymerization using the process of frontal polymerization with continuous forced withdrawal of the resulting polyacrylamide hydrogel by drawing from the top of the reactor, wherein the acrylamide or its derivatives are fed into the reactor at atmospheric pressure.

The invention relates to the field of polymer chemistry and concerns the industrial technology of obtaining superabsorbents, in particular polyacrylamide hydrogel PAH), which can be used in agriculture, medicine, cosmetology, for cleaning oil pipelines and for creating hygiene items.

Polyacrylamide hydrogel is of special interest in terms of both its ability to absorb water and active agents, and its exceptional physical and mechanical properties, which determines the wide field of its application.

Polyacrylamide hydrogels have been one of the most relevant and demanded research topics in the last few decades in various scientific disciplines: chemistry, physics, biology, medicine, etc. Polyacrylamide hydrogels are cross-linked polymer structures, with the ability to swell with the absorption of large amounts of moisture and active agents without destroying the original shape. The special advantage of these hydrogels is to give back absorbed agents to the environment. A wide range of properties of hydrogels, opens up the possibility of their use in a variety of spheres of human activity they are in demand: in agriculture, in bioengineering, in pharmacology, in medicine, in cosmetology, in plastic surgery, in the field of creating items of general hygiene, up to the manufacture of diapers and others. They are produced all over the world, especially active suppliers are the USA, China, Ukraine, etc. However, recently, the U.S., China, and many European countries have refused to use polyacrylamide hydrogels in agriculture and in all areas involving direct human exposure, including diapers, napkins, food processing, and in invasive procedures in the human body. This is due to the fact that PAH, while itself completely safe, is derived from a very toxic monomer, acrylamide. The toxicity of the resulting product is due to the specificity of the traditional synthesis, which takes place over several hours, while the resulting hydrogel, by virtue of its ability, also captures some of the acrylamide from which it is formed. Success in the use of PAH in the spheres of human life, especially in medicine, depends on the properties of the materials used. These materials should certainly be biocompatible, stable and non-toxic.

Traditional methods of synthesis of polyacrylamide hydrogels include carrying out the process in batch reactors in two stages with the third stage—subsequent washing of the product from impurities and residues of toxic monomer—acrylamide. The first and second stages of the process involve synthesizing a linear polymer and then crosslinking the resulting linear polymer to produce a three-dimensional polymer mesh, the hydrogel, which is responsible for the absorbability.

Significant disadvantages of traditional methods of polyacrylamide hydrogels production are their labor intensity, complexity of technology and high energy consumption during the process due to its multistage nature. Also, traditional methods are characterized by low ecological friendliness, and the obtained product is of low quality, which is due, as mentioned above, to the toxicity of the obtained product. In addition, the disadvantages also include difficulties in adjusting the pore size and density (responsible for swelling and release of various active agents and products) during the synthesis process.

These disadvantages are caused, in particular, by the fact that polymerization processes are mainly exothermic reactions, therefore, when they are carried out in batch reactors, where polymerization occurs throughout the entire volume of the reaction mass, not only the removal of the released heat is required in order to avoid a thermal explosion of the reactor, but also reducing the concentration of reagents. In the first case, such an expensive problem is solved by installing cooling devices, and in the second case—by adding solvents to the reacting mixture, which significantly increases the labor intensity of the technology of PAH production. At the same time, for each periodic cycle of production, sufficient energy is consumed to cool the reactor vessel and maintain a constant temperature in the reaction medium. After the end of the process, the solvent is removed from the reactor and either ejected to the outside, or an additional solvent extraction and purification cycle is introduced into the synthesis technology for the next loading into the batch reactor. Moreover, at the end of the process the obtained polymer is removed from the reactor, the reactor is washed and prepared for the next loading. At the same time, it should be noted that prolonged polymerization process in the reactor volume creates conditions for additional undesirable reactions, for example, reactions with the reactor walls, oxidative reactions under the influence of air, etc. Prolonged polymerization process throughout the entire volume of the reaction mass promotes strong adhesion of the reaction mixture and the formed product on the walls of the reactor, resulting in disruption of the structure of polyacrylamide hydrogel when it is removed from the reactor.

Especially undesirable are the reactions of initial monomer capture in the synthesis of polyacrylamide superabsorbents synthesized from acrylamide, which is toxic to the human body, causing a significant deterioration in the quality of the finished product. Despite the fact that polyacrylamide superabsorbents have exceptional advantages compared to the gels available in literature and production, this factor of the presence of residual toxic initial acrylamide in the final product has greatly reduced the price of this superabsorbent gel and some countries (Russia, China, Europe, etc.) have banned its sale and use.

The closest analogue of the present invention is a method for producing polyacrylamide hydrogels by continuous frontal polymerization with the following composition of the initial mixture: a mixture of acrylamide and sodium acrylate—0.1% to 50%; N,N′-methylene bis-acrylamide—0.5% to 8%; initiator, such as potassium persulfate, —0 to 1%; nanoscale bentonite—0.1% to 7%; water—the rest [Russian Federation patent No. 2681212, dated Jul. 9, 2018].

The disadvantage of the closest analogue is the insufficiently high quality of the resulting hydrogel due to the heterogeneity of the resulting hydrogel, which does not allow the most accurate adjustment of the size and density of the pores in the resulting hydrogel. This is due to the fact that frontal polymerization of liquid monomers in continuous tubular reactors, as a rule, is accompanied by sticking of the resulting highly viscous polymer mass to the walls of the reactor, which leads to formation of jet currents, flow velocity gradient along the reactor radius, and, as a result, to the formation of a strongly elongated jet of monomeric liquid, which, having reached the end of the reactor, leaves it without reacting. Thus, using this technology makes it difficult to guarantee a hydrogel of homogeneous structure with a given pore size. In addition, the adhesion of a highly viscous polymer mass to the reactor walls destabilizes the polymerization front, which can lead to attenuation of the spontaneous polymerization process.

Technical problem to be solved by the claimed invention is to eliminate the disadvantages of known solutions and to develop a high-performance, environmentally safe, energy-saving technology for obtaining non-toxic polyacrylamide hydrogel of high quality, and providing a product with precisely defined structural characteristics to regulate both sorption and desorption properties of the hydrogel (properties that ensure absorption and release of liquids).

The technical result achieved in the implementation of the claimed invention consists in reducing the labor intensity in the implementation of the technology of obtaining polyacrylamide hydrogel; in increasing the reliability of the hydrogel production process by achieving stability of the polymerization process, as well as in improving the quality of the resulting polyacrylamide hydrogel by significantly improving the homogeneity of the hydrogel, in the possibility of stable and accurate production of pores of the specified size and density, as well as the elimination of toxicity of the finished product.

The technical result is achieved in the method of obtaining polyacrylamide hydrogels by continuous frontal polymerization, including feeding acrylamide or its derivatives into a vertical continuous reactor from bottom to top and polymerization using the process of frontal polymerization with continuous forced withdrawal of the resulting polyacrylamide hydrogel by drawing from the top of the reactor, wherein the acrylamide or its derivatives are fed into the reactor at atmospheric pressure.

The polyacrylamide superabsorbent hydrogel (PAH) obtained by the present method are crosslinked polymer structures, with the ability to swell with the absorption of a large amount of moisture and active substances without destroying the original shape. The special advantage of the resulting hydrogels is giving back absorbed substances to the environment. For producing these hydrogels, polyacrylamide is used. Polyacrylamide is the common name for a group of polymers and copolymers based on acrylamide and its derivatives.

As initial reagents for producing polyacrylamide hydrogels, in addition to acrylamide or its derivatives (monomers), their mixtures with cross-linking agent and/or polymerization reaction initiator and other additives providing additional possibility to regulate absorption and release of liquids by the finished product can be used.

As a crosslinking agent can be used, for example, N,N′-methylene-bis-acrylamide, as an initiator of the polymerization reaction—potassium persulfate, and as additives providing the possibility of regulating the absorption and release of liquids—colloidal solution of bentonite.

Feeding of the monomer (acrylamide or its derivatives) from the feed tank into the reactor is carried out at atmospheric pressure, i.e. without application of artificially created pressure to move the liquid from the feed tank into the reactor, which can be realized, for example, by using the law of communicating vessels, for the fulfillment of which the feed tank and the reactor are arranged in an appropriate way (in parallel).

The optimal feed rate of the monomer or its mixture with the initiator and/or crosslinking agent into the reaction zone where the frontal polymerization wave is localized is 1-20 cm/min and depends on monomer burning rate or mentioned mixture, which, in turn, depends on the chemical nature of the supplied monomer or components of mentioned mixture.

Forced continuous removal of the synthesized polyacrylamide hydrogel from the reactor neck can be accomplished by drawing the polyacrylamide hydrogel using a wire rope. The produced polyacrylamide hydrogel drawn from the reactor is wound onto spools. The rate of drawing the polyacrylamide hydrogel from the reactor can be equal to the rate of burning of acrylamide or its derivatives in the reactor during frontal polymerization.

Initiation of the frontal polymerization process can be carried out by means of a thermal pulse (local initiation—for example, spot heating) in the mixture section. At the same time, it is necessary to ensure that the reaction temperature in the reactor is maintained in any known way (adiabatic process must be ensured). For the polymerization process, a vertical cylindrical reactor is optimal. The inner walls of the reactor can be coated with a polytetrafluoroethylene layer or an organic silicon rubber layer to reduce wettability with the monomer and the resulting polymer and avoid adhesion.

The implementation of the present method for producing polyacrylamide hydrogels in the frontal polymerization mode in a vertical continuous reactor, with constant feed of initial reagents into the reactor from bottom to top at atmospheric pressure and, accordingly, with constant forced withdrawal of the obtained PAH by drawing through the upper part of the reactor, makes it possible to obtain the highest quality product possible due to the following.

From a technological point of view, the frontal polymerization has incomparable advantages compared to conventional polymerization methods. The traditional process, as mentioned, is carried out in batch reactors, in two stages. At the first stage, a linear polymer is obtained, and at the second stage, this polymer is “crosslinked” to obtain three-dimensional polymer networks. The process starting from the first stage takes place in the whole volume at once and within several hours (in contrast to frontal polymerization (FP), where polymerization spreads from one end of the reactor to the other—in autowave mode).

This process occurs with heat release and in order to avoid thermal explosion in the polymerization process, an appropriate cooling system is put in place, which results in additional energy consumption for cooling the reactor. Further, a reduction in the reaction rate and thus heat generation is required. This is done by adding solvents to the initial reacting mixture, and when the process is completed, these solvents are released into the environment, since other disposal methods greatly affect the cost of the resulting product. Hence the cooling costs and environmental concerns due to the release of solvents into the environment. At the same time, the main disadvantage in the case of polyacrylamide hydrogel is the product itself, in which some amounts of poisonous acrylamide will always remain.

In frontal polymerization mode, however, the polymer production process takes place in one stage due to the FP specifics taking place in the autowave propagation mode of the polymerization reaction from one end of the reactor to the other. All undesirable phenomena characteristic of the traditional method are leveled in the conditions of autowave process in the frontal polymerization mode under continuous conditions. This is due to the fact that in FP the whole process takes place at a high rate of simultaneous polymerization and cross-linking, resulting in a high-quality product, in particular without residual acrylamide: since the process is fast, the reaction wave forces all side impurities. Thus, carrying out the process in the frontal polymerization mode allows to obtain a safe product with no traces of toxic acrylamide, which allows to use the obtained hydrogel in medicine, agriculture, as well as in hygienic accessories without harm to health.

In addition, since the driving factor of the FP process is the heat released during the reaction, and the technology is based specifically on the preservation of this heat to avoid loss of reaction rate and attenuation of the polymerization wave, in this case, there is no need to cool the reactor or to reduce the reaction rate by, adding solvent (this is due to the productivity of the process and energy benefits from the exclusion of the stages of initial heating and subsequent cooling of the reactor). The high productivity of the process is further caused by the realization of FP in continuous reactors with constant feed of the reaction mixture and constant withdrawal of the obtained PAH.

During the study process, it was found that in the process of FP under certain conditions (at occurrence of adhesion of the reacting mass on the reactor walls), a curved polymerization front (combustion front) can form. The formation of a curved front is accompanied by the occurrence of jet currents and flow velocity gradient along the radius of the reactor and, as a result, to the formation of a strongly elongated jet of monomeric liquid, which, having reached the end of the reactor, leaves it without reacting.

As a result, polymerization is carried out unevenly, that is, in the presence of a curved front, unreacted monomer zones remain in the product by the time of extraction from the reactor, which significantly reduces the uniformity of PAH production, excludes the possibility of stable and accurate production of the product with pores of specified size and density.

Also, due to the formation of a curved front, unequal stay times of the product across the pipe section, and the formation of a polymer in significantly heterogeneous temperature fields are established. These factors generate heterogeneity in the properties of the resulting polymer.

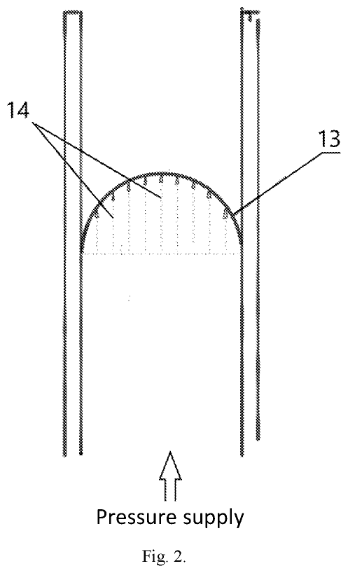

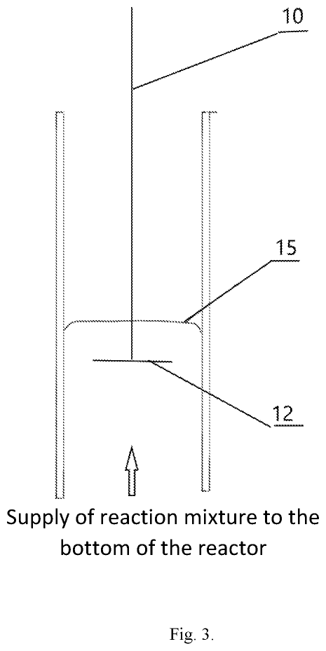

It was found that the forced feeding of the reaction mixture into the reactor from the feed tank under the action of artificially created pressure (e.g., by a compressor or pump) promotes the formation of a curved polymerization line (see FIG. 2). At the same time, the implementation in the claimed method of feeding the reaction mixture in a vertical reactor from bottom to top in the absence of pressure (at atmospheric pressure) (see FIG. 3) and with continuous drawing of the resulting polymer upward (from the top of the reactor) from the reactor allows to significantly reduce the adhesion of the reacting mass on the reactor walls and exclude the formation of a curved front at which the jet currents and the gradient of flow velocities along the radius of the reactor are formed. It is observed that the polymerization line is geometrically close to the plane, and the front is stabilized. As a result, the monomer polymerizes uniformly throughout the process and, as a result, an increase in the quality of polyacrylamide hydrogel is achieved due to the stable production of polymer with a high degree of homogeneity and regularity of the structure with pores of a given size and density. At the same time, good reproducibility of the structure of the finished product is achieved.

The possibility to realize the FP in one stage significantly reduces the labor intensity of the claimed method and leads to speeding up the process of obtaining the finished product.

The use of a reactor whose inner walls are covered with a polytetrafluoroethylene layer or an organic silicon rubber layer also makes it possible to reduce the interaction of the reacting mass and the finished product with the reactor walls by reducing the reactor wall wetting with reacting mass and the finished polymer. This provides an additional improvement in the quality of the resulting polyacrylamide hydrogel by increasing the degree of homogeneity of the hydrogel structure.

Implementation of the present method in the mode of frontal polymerization in a vertical continuous reactor, in combination with constant feeding of initial reagents into the reactor from bottom to top at atmospheric pressure (without applying pressure from outside) and with constant forced withdrawal of the obtained PAH by drawing from the upper part of the reactor also allows to achieve increased reliability of the process of frontal polymerization due to stabilization of the polymerization front (combustion front) and, as a result, the exclusion of its sudden attenuation with the cessation of the polymerization process.

The possibility of stabilizing the front is caused by the fact that the continuous feeding of initial reagents into the vertical reactor at atmospheric pressure from bottom to top makes it possible to exclude sticking of viscous reacting mass on the reactor walls, and, as a result, periodic stretching of the front with formation of jet currents, leading to instability of the combustion front, and to obtain a polymerization line that remains stable throughout the process being geometrically close to a plane. With this geometry of the polymerization line, the process runs uniformly and stably without sudden outbursts caused by jet currents, which can lead to the attenuation of the combustion front and stop the polymerization process.

During the study process, it was found that in the presence of a curved front in which jet currents are formed, polymerization is not uniform, that is, jet currents can contribute to the release of monomer on the reactor walls into the area of synthesized PAH leading to the adhesion of monomer on the reactor walls and difficulty in extracting PAH.

Thus, obtaining a stable polymerization line throughout the process being geometrically close to a plane, the absence of a curved front, in which the monomer jet currents are formed, contributes to a uniform polymerization of monomer along the entire front resulting in no sticking of monomer on the walls of the reactor impeding the extraction of synthesized PAH. In this regard, the extraction of PAH is carried out smoothly while maintaining the intensity of the combustion of the front to ensure a continuous polymerization process that eliminates the attenuation of the front.

Thus, implementation of the method of producing polyacrylamide hydrogel by feeding the reaction mixture into a vertical reactor from bottom to top in the absence of pressure and carrying out the process of frontal polymerization with continuous drawing of the polymer through the neck of the reactor makes it possible to significantly improve the quality of the produced hydrogel through stable obtaining of a product with a precisely defined structure, and, as a result, to regulate both sorption and desorption properties of the hydrogel.

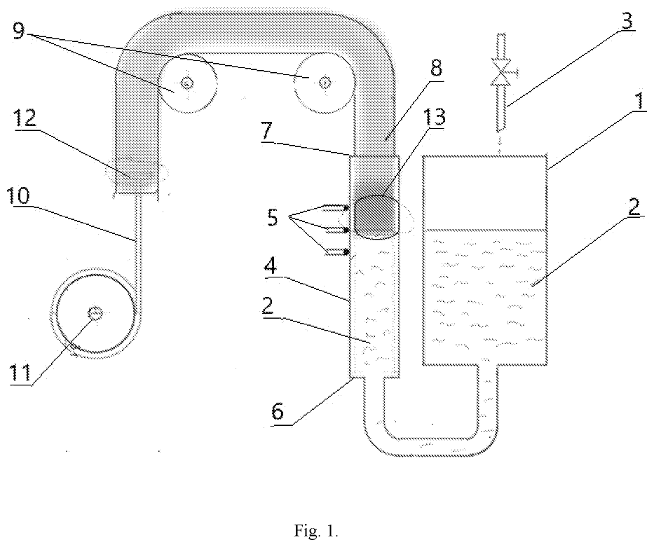

The essence of the invention is explained in FIGS. 1-7.

FIG. 1 shows a schematic diagram of the polyacrylamide hydrogel production according to the claimed method.

FIG. 2 illustrates a curved polymerization front line when implementing frontal polymerization with a pressurized feed of the reaction mixture.

FIG. 3 illustrates the polymerization front line being geometrically close to a plane.

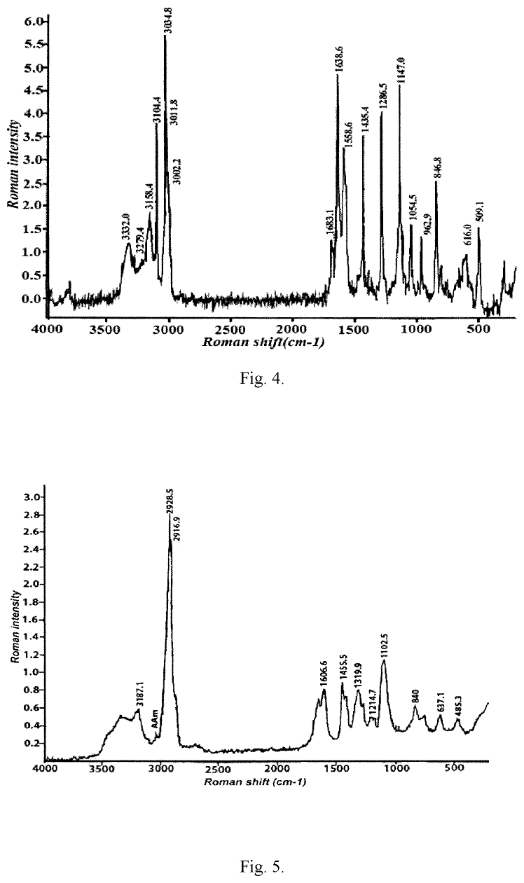

FIG. 4 shows roman spectra of pure acrylamide.

FIG. 5 shows roman spectra of crystalline polyacrylamide.

FIG. 6 shows roman spectra of PAH.

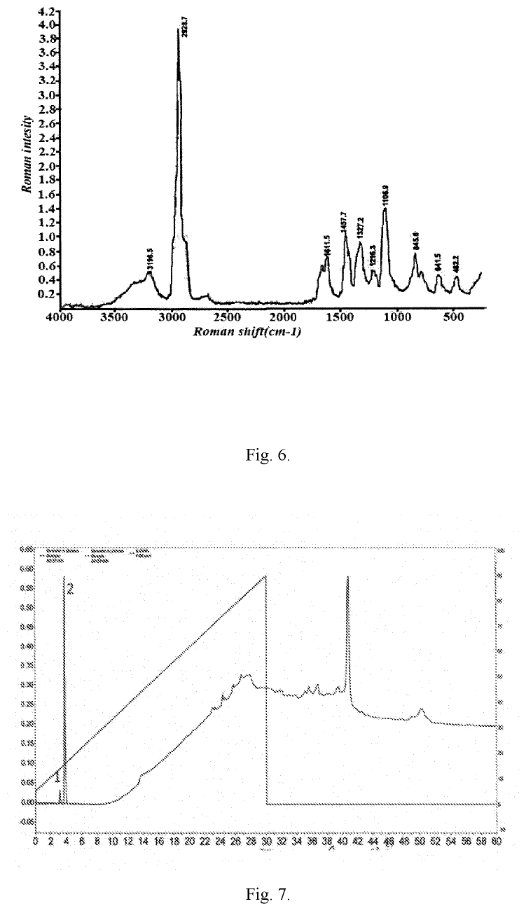

FIG. 7 shows data obtained by gel chromatography.

In the figures, positions 1-15 indicate:
1—feed tank,
2—reaction mixture,
3—filling valve,
4—vertical reactor,
5—thermocouples,
6—the lower part of the reactor,
7—the upper part of the reactor,
8—polyacrylamide hydrogel being produced,
9—driven rollers,
10—drawing rope for the obtained polyacrylamide hydrogel,
11—controlled motor,
12—rope attachment element for the obtained polyacrylamide hydrogel,
13—incurved polymerization line,
14—jet currents,
15—polymerization front line being geometrically close to a plane.

The claimed invention is realized as follows.

To carry out the polymerization process in the FP mode, the feed tank 1 is connected to the bottom part 6 of the vertical reactor 4. Feed tank 1 is placed parallel to reactor 4. Further, the feed tank 1 is filled with the reaction mixture 2 by opening the filling valve 3 and the reaction mixture 2 is continuously fed into the reactor 4. The reaction mixture enters the reactor by gravity until the level of the mixture in the reactor 4 reaches the level of the liquid mixture in the feed tank 1 (since the feed tank and the reactor are communicating vessels). The feed rate of the reaction mixture into the reaction zone where the polymerization wave is localized is 10 cm/min. To maintain the level of the reaction mixture in the reactor, the reaction mixture is continuously fed into the feed tank at the same rate. The reaction mixture 2 is fed into the reactor 4 at the lower part of the reactor 6. The frontal polymerization process is initiated by means of a thermal pulse (spot heating) in the mixture section. In the reactor, the adiabatic temperature is maintained throughout the process. The temperature in the reactor is monitored using a thermocouple 5. In the frontal polymerization mode, the processes of polymerization and “cross-linking” of the formed polymers with the formation of three-dimensional polymer networks responsible for the sorption properties of the final product occur simultaneously at high speed in the reactor. Frontal polymerization proceeds in the autowave propagation mode of the polymerization reaction. Feeding the reaction mixture 2 into the reactor 4 from bottom to top by gravity without applying pressure created by a compressor or pump, with continuous forced extraction of PAH 8 from the reactor 4 by a drawing rope 10 contributes to minimizing the adhesion of the reaction mixture on the walls of the reactor and the formation of the polymerization front line 15 being geometrically close to a plane. Under these conditions, curving of the polymerization front line 13 with the occurrence of jet currents 14 is excluded. As a result, there is no formation of a strongly elongated jet of monomeric liquid throughout the process of obtaining PAH 8, which reaches the end of the reactor, leaves it without reacting, which contributes to increasing the homogeneity of the obtained PAH. The generated PAH 8 is continuously withdrawn through the upper part of the reactor 7 (neck) using a drawing rope 10 attached to the end of the PAH 8 by means of a rope attachment element 12. When motor 11 is turned on, PAH 8 is drawn out of the reactor and wound onto the spool. The driven rollers 9 provide reliable extraction of PAH 8 from the reactor 4.

The results of the study of structural characteristics of PAH samples (samples 1-6) obtained by the developed method are presented in the table. PAH samples 7-10 were obtained according to the alternative method (synthesis conditions differ from the claimed method by the parameters indicated in the table, other synthesis stages were carried out according to the claimed method described above) and are given for comparison.

TABLE

| | | Presence/absence of | | | |
|---|---|---|---|---|---|
| | | pressure generated by | Direction of the | Forced | |
| PAH | | the compressor when | reaction mixture | withdrawal | Pore size |
| sample | Composition of the reaction | feeding the reaction | feeding to the | of PAH by | distribution in the |
| no. | mixture | mixture | reactor | drawing out | obtained PAH |
| 1 | Acrylamide solution - 21.875%, | Absence (the reaction | Vertical reactor, | + | 20 μm - 90%, |
| | sodium acrylate - 21.875%, | mixture is fed by gravity | bottom-to-top | (upwards) | 17 μm - 10% |
| | potassium persulfate 0.3125%, | at a rate of 10 cm/min) | feeding | | |
| | water - 55.9375% | | | | |
| 2 | Acrylamide solution - 12.5%, | Absence (the reaction | Vertical reactor, | + | 22 μm - 89%, |
| | sodium acrylate - 31.25%, | mixture is fed by gravity | bottom-to-top | (upwards) | 18 μm - 11% |
| | potassium persulfate 0.3125%, | at a rate of 10 cm/min) | feeding | | |
| | water 55.9375%. | | | | |
| 3 | Acrylamide solution 20.625%, | Absence (the reaction | Vertical reactor, | + | 19 μm - 93%, |
| | Na acrylate 21.875%, | mixture is fed by gravity | bottom-to-top | (upwards) | 20 μm - 7% |
| | potassium persulfate 0.3125%, | at a rate of 10 cm/min) | feeding | | |
| | water 55.9375%, | | | | |
| | N,N′-methylene-bis- | | | | |
| | acrylamide 1.25%. | | | | |
| 4 | Acrylamide solution - 21.875%, | Absence (the reaction | Vertical reactor, | + | 21 μm - 92%, |
| | Na acrylate - 21.8%, | mixture is fed by gravity | bottom-to-top | (upwards) | 19% - 8% |
| | water - 55.9375%. | at a rate of 10 cm/min | feeding | | |
| 5 | Acrylamide solution - 21.875%, | Absence (the reaction | Vertical reactor, | + | 20 μm - 92%, |
| | sodium acrylate - 21.875%, | mixture is fed by gravity | bottom-to-top | (upwards) | 18 μm - 8% |
| | potassium persulfate 0.3125%, | at a rate of 10 cm/min) | feeding | | |
| | water 55.3775%, | | | | |
| | bentonite 0.56% | | | | |
| 6 | Acrylamide solution - 21.875%, | Absence (the reaction | Vertical reactor, | + | 21 μm - 93%, |
| | sodium acrylate - 21.875%, | mixture is fed by gravity | bottom-to-top | (upwards) | 19 μm - 7% |
| | potassium persulfate 0.3125%, | at a rate of 10 cm/min) | feeding | | |
| | water 55.3775%, | | | | |
| | bentonite 0.56% | | | | |
| 7 | Acrylamide solution - 21.875%, | Presence (reaction mixture | Horizontal reactor, | | 80 μm - 56%, |
| | sodium acrylate - 21.875%, | is fed into the reactor | left-to-right feeding | | 60 μm - 20% |
| | potassium persulfate 0.3125%, | using a compressor, feed | | | 20 μm - 20%, |
| | water - 55.9375% | rate is 10 cm/min) | | | 15 μm - 4% |
| 8 | Acrylamide solution - 21.875%, | Absence (the reaction | Horizontal reactor, | + | 75 μm - 64%, |
| | sodium acrylate - 21.875%, | mixture is fed by gravity | left-to-right feeding | (to the | 70 μm - 26% |
| | potassium persulfate 0.3125%, | at a rate of 10 cm/min) | | right) | 50 μm - 7%, |
| | water - 55.9375% | | | | 28 μm - 3% |
| 9 | Acrylamide solution - 21.875%, | Presence (reaction mixture | Vertical reactor, | + | 35 μm - 48%, |
| | sodium acrylate - 21.875%, | is fed into the reactor | top to bottom | (downwards) | 70 μm - 15%, |
| | potassium persulfate 0.3125%, | using a compressor, feed | | | 28 μm - 10%, |
| | water - 55.9375% | rate is 10 cm/min) | | | 16 μm - 27% |
| 10 | Acrylamide solution - 21.875%, | Presence (reaction mixture | Vertical reactor, | + | 80 μm - 37%, |
| | sodium acrylate - 21.875%, | is fed into the reactor | bottom to top | (upwards) | 47 μm - 24%, |
| | potassium persulfate 0.3125%, | using a compressor, feed | | | 23 μm - 20%, |
| | water - 55.9375% | rate is 10 cm/min) | | | 11 μm - 15%, |
| | | | | | 5 μm - 4% |

Thus, the results of the study confirm that the developed method allows to achieve PAH (samples 1-6) with improved homogeneity, good structure reproducibility in parallel processes. At the same time, no attenuation of the polymerization front was observed throughout the process, the process ran stable.

In addition, the results of the study of PAH samples obtained in accordance with the claimed method, namely, by scanning spectroscopy and gel chromatography methods confirmed that the obtained samples do not contain even traces of toxic acrylamide (FIG. 4-7).

When PAH samples (samples 7-10) were obtained by the alternative method, the polymerization process was interrupted from 2 to 5 times due to the attenuation of the polymerization front, which required re-initiation of the process. In addition to heterogeneity (in terms of pore distribution), areas of unreacted monomer of different sizes were found in the volume of each of the obtained PAH samples.

Thus, the advantages of the developed method of producing PAH were experimentally confirmed. The developed method can be used for the synthesis of polyacrylamide hydrogels under conditions that are superior to the currently existing methods of synthesis (including traditional ones) of these gels, both in terms of process efficiency, environmental safety, and in terms of properties of the obtained polyacrylamide superabsorbent hydrogel.

1. The method of producing polyacrylamide hydrogels by continuous frontal polymerization, including feeding acrylamide or its derivatives into a vertical continuous reactor from bottom to top and polymerization using the process of frontal polymerization with continuous forced withdrawal of the resulting polyacrylamide hydrogel by drawing from the top of the reactor, wherein the acrylamide or its derivatives are fed into the reactor at atmospheric pressure.
